(19) United States
(12) Patent Application Publication
(10) Pub. No.: US 2024/0266656 A1
(43) Pub. Date: Aug. 8, 2024

(54) BATTERY PACK INCLUDING IMPACT SENSING MODULE

(71) Applicant: LG ENERGY SOLUTION, LTD., Seoul (KR)

(72) Inventor: Chi Ho AHN, Daejeon (KR)

(73) Assignee: LG ENERGY SOLUTION, LTD., Seoul (KR)

(21) Appl. No.: 18/564,988

(22) PCT Filed: Dec. 20, 2022
(86) PCT No.: PCT/KR2022/020848

§ 371 Date: Nov. 28, 2023

(30) Foreign Application Priority Data
Jan. 6, 2022 (KR) 10-2022-0002194

(51) Int. Cl. H01M 50/242; G01L 5/00; H01M 10/42; H01M 10/48; H01M 50/579

(52) U.S. Cl. CPC H01M 50/242; G01L 5/0052; H01M 10/425; H01M 10/48; H01M 50/579; H01M 2010/4271

(57) ABSTRACT

A battery pack with a shock detection module, and a battery pack for detecting a strength of a shock applied to the battery pack step by step by applying a shock detection module structure to a battery management system (BMS) and performing BMS control.

### TECHNICAL FIELD

The present invention relates to a battery pack with a shock detection module, and more particularly, to a battery pack capable of controlling a pack operation in accordance with strength of a shock by detecting the strength of the shock step by step with a voltage change according to the connection of a resistor caused by the shock.

### BACKGROUND ART

A battery is widely used in various fields ranging from a small electronic device such as a smartphone, laptop, and tablet PC to an electric vehicle and an energy storage system (ESS).

A battery (pack) is typically composed of a configuration including a plurality of the assembly each of which includes a plurality of unit cells, and the cell includes a positive electrode current collector, a separator, an active material, an electrolyte solution, an aluminum thin film layer, etc., and thus has a structure capable of charging and discharging by an electrochemical reaction between the components.

In addition to this basic structure for charging and discharging, the battery is additionally configured with a physical protection device, various sensing means, firmware applied with a precise algorithm for estimating a state of charge (SOC), etc., from the cell to the battery through the assembly.

When a physical shock is applied to such a battery (pack), deformation of the physical form such as a pouch, housing, frame, etc. of the battery or the cells constituting the battery may be caused, which may lead to a change in resistance or electrical characteristic value of the battery or the cell.

However, conventionally, there is no means for detecting an external shock on the battery pack and controlling or blocking the pack operation, and there is a problem in that the safety of the battery pack due to a physical shock is not secured.

As prior art related to the present invention, there is a following document.
Patent document 1: KR 1053352 B1

### DISCLOSURE OF THE INVENTION

### Technical Problem

The present invention is intended to solve the problems described above, and to provide a battery pack configured to detect a strength of a shock applied to the battery pack step by step by applying a shock detection module structure to a battery management system (BMS) and perform BMS control for this.

### Technical Solution

In order to solve the problems described above, the present invention provides a battery pack configured to include a battery management system (BMS) and a shock detection module that detects a shock strength applied to the battery pack, in which the BMS is configured to include a reference voltage source Vref for shock detection, a reference resistor R_{ref} connected to the reference voltage source V_{ref}, and a voltage measurement unit that measures a distributed voltage between the reference resistor R_{ref} and a measurement resistor R₀, and the shock detection module is configured to include a non-conductive barrier wall connected to an inside of a case of the battery pack through an elastic body, the measurement resistor R₀ connected to the reference resistor R_{ref}, and first and second resistors R₁ and R₂ respectively connected to both ends of the non-conductive barrier wall through hinges and respectively having a first end connected to the ground and a second end connected to the measurement resistor R₀.

The BMS may be configured to further include a comparison and determination unit that compares whether a predetermined shock arrival condition is satisfied based on the distributed voltage measurement value of the voltage measurement unit and determines a degree of shock applied to the battery pack according to the comparison result, and a pack operation control unit that controls an operation of the battery pack in response to the determination result of the comparison and determination unit.

The second ends of the first resistor and the second resistor are disposed at a predetermined interval or less with respect to the measurement resistor R₀, so that when vibration is applied to the battery pack case, the first and second resistors R₁ and R₂ come into contact with the measurement resistor R₀ to cause a change in the distributed voltage measurement value of the voltage measurement unit, and an interval d1 at which the first resistor R₁ is disposed adjacent to the measurement resistor R₀ is different from an interval d2 at which the second resistor R₂ is disposed adjacent to the measurement resistor R₀. In addition, since d1 and d2 are different, the distributed voltage value measured by the voltage measurement unit varies according to a degree of vibration generated in the battery pack.

In this case, the measurement resistor R₀ is formed at a fixed position on a BMS board constituting the BMS and includes a contact portion with the first and second resistors R₁ and R₂, and the first and second resistors R₁ and R₂ are connected to the non-conductive barrier wall with an elastic body being displaceable due to external vibration, the distributed voltage is measured as a voltage at the moment when the first and second resistors R₁ and R₂ come into contact with the measurement resistor R₀, and the distributed voltage is measured as a different value according to a degree of the external vibration.

In the battery pack, the comparison and determination unit compares whether the distributed voltage measurement value of the voltage measurement unit is the same as a first reference voltage value, and when the distributed voltage measurement value of the voltage measurement unit is the same as a first reference voltage value, determines that no shock is being applied to the battery pack, compares whether a number of cycles in which the distributed voltage measurement value of the voltage measurement unit alternates between the first reference voltage value and a second reference voltage value has reached a predetermined number of shocks, and when the number of cycles has reached the predetermined number of shocks, determines that a weak shock is being continuously applied to the battery pack, and compares whether the distributed voltage measurement value of the voltage measurement unit has reached a third reference voltage value, and when it has reached the third reference voltage value, determines that a strong shock has been applied to the battery pack.

The present invention provides a battery pack shock detecting method of detecting an external shock state in the battery pack described above, the battery pack shock detecting method including a distributed-voltage measurement step of measuring a distributed voltage at a connection point between a reference resistor R_{ref} connected to a reference voltage source V_{ref} for implementing shock detection on a BMS board and a measurement resistor R₀ of a shock detection module, a whether-a-shock-arrival-condition-is-satisfied comparison step of comparing whether or not a predetermined shock arrival condition is satisfied based on the distributed voltage value measured in the distributed-voltage measurement step, and a shock state determination step of determining a degree of shock applied to the battery pack according to the comparison result in the whether-a-shock-arrival-condition-is-satisfied comparison step.

The battery pack shock detection method may further include a pack operation control step of controlling an operation of the battery pack in response to a determination result in the shock state determination step, and, in the whether-a-shock-arrival-condition-is-satisfied comparison step, whether the measured distributed voltage value is the same as a first reference voltage value is compared, whether the number of cycles in which the measured distributed voltage value alternates between the first reference voltage value and a second reference voltage value has reached a predetermined number of shocks is compared, and whether the measured distributed voltage value has reached a third reference voltage value is compared.

In addition, in the shock state determination step, when the measured distributed voltage value is the same as the first reference value as a result in the whether-a-shock-arrival-condition-is-satisfied comparison step, it is determined that it is a state in which there is no external shock applied to the battery pack, when the number of cycles in which the measured distributed voltage value alternates between the first reference voltage value and a second reference voltage value has reached a predetermined number of shocks, it is determined that it is a state in which a weak shock is continuously applied to the battery pack, and when the measured distributed voltage value has reached a third reference voltage value, it is determined that a strong shock has been applied to the battery pack.

### Advantageous Effects

The present invention can provide improved safety against an external shock by detecting strength of the shock step by step through a voltage change according to the connection of a resistor caused by the shock and controlling the operation of the battery pack according to the strength of shock.

### BRIEF DESCRIPTION OF THE DRAWINGS

FIG. 1 is a diagram schematically illustrating a battery pack according to an embodiment of the present invention.

FIG. 2 is a diagram illustrating a configuration of a shock detection module according to an embodiment of the present invention.

FIG. 3 is a diagram schematically illustrating the shock detection module of FIG. 2 as a circuit.

FIG. 4 is a diagram illustrating an operation of the shock detection module assuming a case in which a weak shock is applied to the battery pack.

FIG. 5 is a diagram illustrating an operation of the shock detection module assuming a case in which a strong shock is applied to the battery pack.

FIG. 6 is a diagram illustrating an example of voltage measurements when a strong shock is applied to the battery pack.

### MODE FOR CARRYING OUT THE INVENTION

Hereinafter, embodiments of the present invention will be described in detail with reference to the accompanying drawings so that those of ordinary skill in the art can easily carry out the present invention. However, the present invention may be embodied in various different forms and is not limited to the embodiments described herein. In order to clearly explain the present invention in the drawings, parts irrelevant to the description are omitted, and similar reference numerals are assigned to similar parts throughout the specification.

Hereinafter, the present invention will be described in detail with reference to the drawings.

### 1. Battery Pack According to the Present Invention

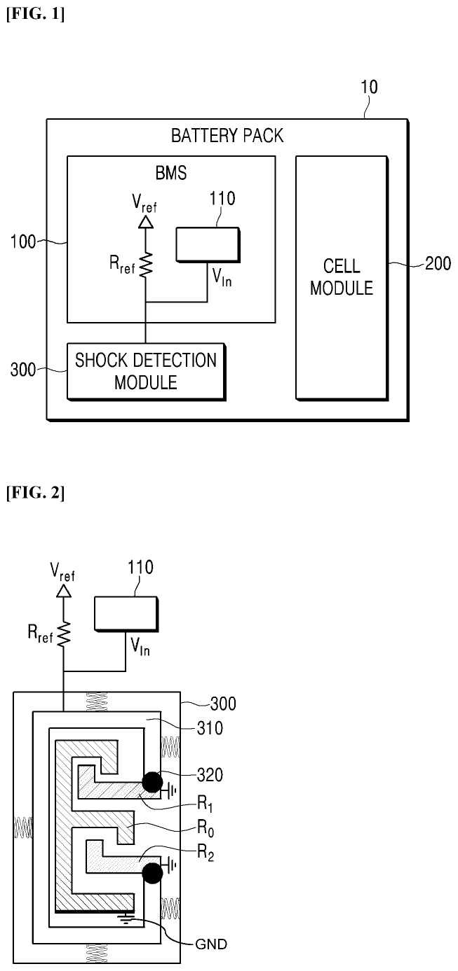

FIG. 1 is a diagram schematically illustrating a battery pack according to an embodiment of the present invention.

Referring to FIG. 1, a battery pack 10 of the present invention largely includes a BMS module (also referred to as a BMS herein) 100, a cell module 200, and a shock detection module 300.

### 1.1. BMS Module 100

As illustrated in FIG. 1, the BMS module 100 according to the present invention is configured to include a reference voltage source V_{ref} for implementing shock detection, a reference resistor R_{ref} connected to the reference voltage source V_{ref}, and a voltage measurement unit 110 that measures a distributed voltage V_{In} at a connection point between the reference resistor R_{ref} and a measurement resistor pattern (also referred to as a measurement resistor herein) R₀ formed in the shock detection module 300 to be described later, and may further include a control unit (not illustrated) to be described later.

### 1.2. Cell Module 200

The cell module 200 may include one or more battery cells (not illustrated).

### 1.3. Shock Detection Module 300

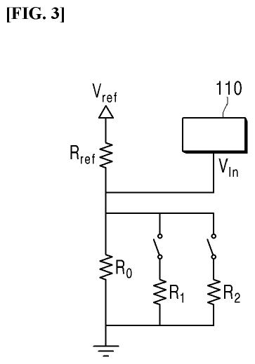

FIG. 2 is a diagram illustrating a configuration of the shock detection module according to an embodiment of the present invention.

The shock detection module 300 has a configuration capable of detecting the strength of a shock applied to the battery pack 10 step by step, and may include the following configurations.

The shock detection module 300 of the present invention may be installed on a different part of the battery pack by being formed on a separate board from the BMS module described above, or may be disposed together on a PCB board on which the BMS module is formed.

### 1.3.1. Non-Conductive Barrier Wall 310

The non-conductive barrier wall (also referred to as the non-conductive barrier rib herein) 310 may be configured to be connected to a case of the battery pack 10 with an elastic body so that displacement occurs according to vibration of the battery pack 10, or configured to be connected to a board on which the non-conductive barrier wall 310 is formed with an elastic body.

As illustrated in FIG. 2, the non-conductive barrier wall 310 is formed to surround the measurement resistor pattern R₀ to be described later.

Here, the elastic body may be implemented as, for example, a spring having restoring force.

### 1.3.2. Measurement Resistor Pattern R₀

The measurement resistor pattern R₀ is formed inside the non-conductive barrier wall 310 be spaced apart therefrom and one end thereof is connected to the reference resistor R_{ref}.

1.3.3. First and Second Resistors R₁ and R₂

The first and second resistors R₁ and R₂ are respectively connected to ends of the non-conductive barrier 310 and one ends thereof are respectively connected to a ground GND. More specifically, the first and second resistors R₁ and R₂ have a form in which they are respectively connected to both ends of the non-conductive barrier wall 310 through hinges 320, and one ends thereof are respectively connected to the ground GND and the other ends thereof are respectively disposed adjacent to the measurement resistor pattern R₀.

As illustrated in FIG. 2, the other ends of the first resistor R₁ and the second resistor R₂ are disposed adjacent to the measurement resistor pattern R₀ at a predetermined interval or less, and an interval at which the first resistor R₁ is disposed adjacent to the measurement resistor pattern R₀ and an interval at which the second resistor R₂ is disposed adjacent to the measurement resistor pattern R₀ are set to be different from each other. Due to this difference in disposition interval, when vibration is applied to a battery pack case by a shock from the outside of the battery pack 10, a displacement occurs in the non-conductive barrier wall 310 fixed by a spring, and the first and second resistors R₁ and R₂ connected thereto come into contact with the measurement resistor pattern R₀, such that a change occurs in a distributed voltage value V_{In} measured by the voltage measurement unit 110 of the BMS 100.

The hinges 320 have a restoring force, and mechanically prevent the connection between the first and second resistors R₁ and R₂ and the non-conductive barrier wall 310 from being damaged even if a very large displacement occurs in the non-conductive barrier 310 due to an external shock. In addition, when the non-conductive barrier wall 310 returns to its original position after the shock, the restoring force of the hinges may be set such that the first and second resistors are separated from the measurement resistor pattern R₀ or remain in contact with the measurement resistor pattern R₀. In these different cases, changes may be made to a determination of a shock level and a control of an operation of the battery pack, which will be described later. For example, depending on a case, in setting the hinges 320 so that the first resistor and the second resistor come in contact with the measurement resistor pattern R₀ for a while according to the occurrence of displacement and then separate, the restoring force strength of the hinges may be set so that the hinge displaces and returns with a time difference from the return of the non-conductive barrier wall 310 in order for the first resistor and the second resistor to be in contact with the measurement resistor pattern for a predetermined time or more to give a sufficient distributed-voltage measurement time, and the degree of the restoring force of the hinges may be set so that the positions of the first and second resistors are not restored even if the non-conductive barrier wall 310 returns, if necessary.

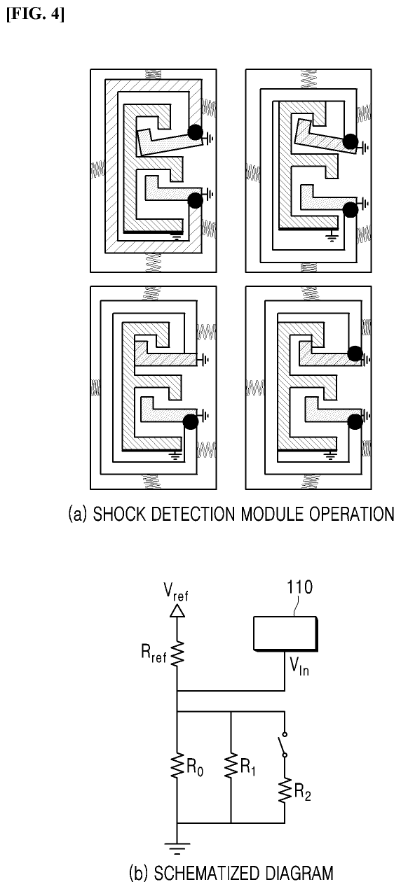

FIG. 3 is a diagram schematically illustrating the shock detection module of FIG. 2 as a circuit. Referring to FIG. 3, the distributed voltage measurement value V_{In} detected by the voltage measurement unit 110 of the BMS 100 due to the voltage distribution between the reference resistor R_{ref} and the measurement resistor R₀ is expressed by the following equation.

$${V}_{In} = \frac{{R}_{0}}{{R}_{ref} + {R}_{0}} \cdot {V}_{ref} \qquad ( Equation 1 )$$

### 1.4. Control Unit (not Illustrated)

The control unit may compare whether or not a predetermined shock arrival condition is satisfied based on the distributed voltage measurement value V_{In} detected by the voltage measurement unit 110, and determine a shock level according to the comparison result. In addition, the control unit may control an operation of the battery pack in response to the determination result.

### 1.4.1. Comparison and Determination Unit

The comparison and determination unit may compare whether or not an external shock currently applied to the battery pack reaches the predetermined shock level using the distributed voltage measurement value detected by the voltage measurement unit 110, and determine the degree of external shock depending on whether the shock level is reached or not.

<Case 1: State without Shock>

The comparison and determination unit compares whether the distributed voltage measurement value of the voltage measurement unit 110 is the same as the first reference voltage value, and determines that there is no shock applied to the battery pack when they are the same.

When an operating state of the shock detection module is as shown in FIGS. 2 and 3, the distributed voltage measurement value V_{In} of the voltage measurement unit 110 has the same value as the first reference voltage value.

Here, the first reference voltage value may be a value calculated by (Equation 1) described above.

<Case 2: State in which a Weak Shock is Continuously Applied>

The comparison determining unit counts a pulse cycle in which the distributed voltage measurement value of the voltage measurement unit 110 goes back and forth between the first reference voltage value and a second reference voltage value, compares whether the counted number of times has reached a predetermined number of shocks, and determines that a weak shock is continuously applied to the battery pack when the counted number of times has reached the predetermined number of shocks.

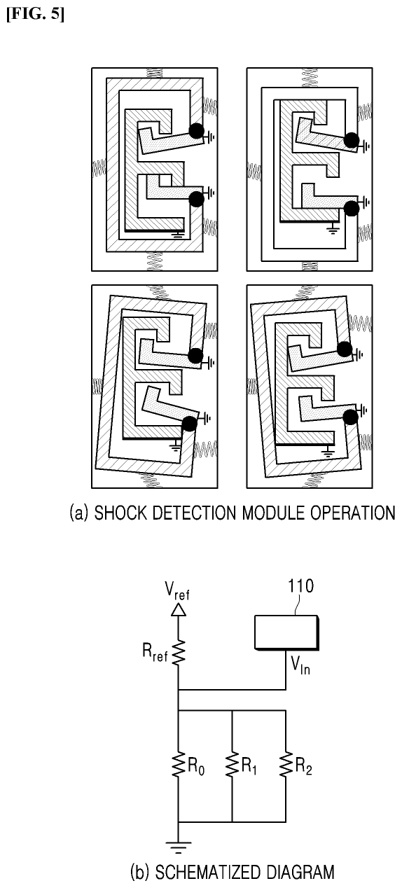

FIG. 4 is a diagram illustrating an operation of a shock detection module assuming a case in which a weak shock is applied to the battery pack.

Referring to FIG. 4, as described above, since a gap between the measurement resistor R₀ and the first resistor R₁ and a gap between the measurement resistor R₀ and the second resistor R₂ are differentially arranged, even when the measurement resistor R₀ and the first resistance R₁ come into contact with each other due to the weak shock, the measurement resistor R₀ and the second resistor R₂ do not come into contact with each other. When this state is schematized into a circuit as shown in (b) of FIG. 4 and the weak shock is applied, if a distributed voltage measurement value V_{Inw} detected by the voltage measurement unit 110 is calculated, it is expressed by the following equation.

$${V}_{Inw} = \frac{\frac{{R}_{0} + {R}_{1}}{{R}_{0} {R}_{1}}}{{R}_{ref} + \frac{{R}_{0} + {R}_{1}}{{R}_{0} {R}_{1}}} \cdot {V}_{ref} \qquad ( Equation 2 )$$

Due to the continuous residual shock applied from the external environment, the measurement resistor R₀ and the first resistor R₁ may repeat a contacting state and a non-contacting state, and a voltage level is also detected in the form of a pulse going back and forth between the first and second reference voltages in accordance with the shock. Using this principle, in one embodiment, a case in which a slight shock is continuously applied to the battery pack may be determined by comparing whether the pulse cycle, in which the distributed voltage measurement value of the voltage measurement unit 110 alternates between the first reference voltage value and the second reference voltage value, has reached a predetermined number of shocks. In another embodiment, a case in which the weak shock to the battery pack is continuously applied may be determined by comparing whether or not the distributed voltage measurement value V_{In} is continuously detected as the same value as the second reference voltage value for a predetermined number of shocks, after the distributed voltage measurement value V_{In} of the voltage measurement unit 110 is initially detected as the same value as the first reference voltage value.

Here, the second reference voltage value may be a value calculated by (Equation 2) above.

<Case 3: State where Strong Shock is Applied>

The comparison and determination unit compares whether the distributed voltage measurement value V_{In} of the voltage measurement unit 110 has reached a third reference voltage value, and determines that a strong shock has been applied to the battery pack when it has reached the third reference voltage value.

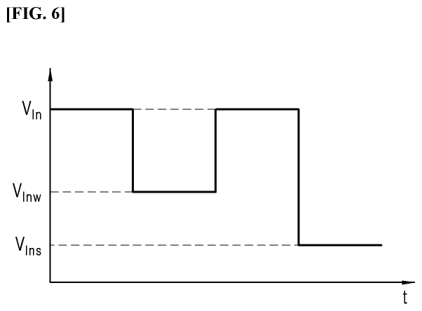

FIG. 5 is a diagram illustrating an operation of the shock detection module assuming a case in which a strong shock is applied to the battery pack.

Referring to FIG. 5, when the non-conductive barrier 310 is shaken violently by the strong shock, the measurement resistor R₀ and the first and second resistors R₁ and R₂ all come into contact with each other. When this is schematized into a circuit as shown in (b) of FIG. 5 and a distributed voltage measurement value V_{Ins} detected by the voltage measurement unit 110 is calculated, it is expressed by the following equation.

$${V}_{Ins} = \frac{\frac{{R}_{0} {R}_{1} + {R}_{1} {R}_{2} + {R}_{0} {R}_{2}}{{R}_{0} {R}_{1} {R}_{2}}}{{R}_{ref} + \frac{{R}_{0} {R}_{1} + {R}_{1} {R}_{2} + {R}_{0} {R}_{2}}{{R}_{0} {R}_{1} {R}_{2}}} \cdot {V}_{ref} \qquad ( Equation 3 )$$

In this case, the voltage of V_{Ins} compared to V_{In} and V_{Inw} is lowered. When comparing the magnitudes of the three voltage values, it can be expressed in the form of a graph as illustrated in FIG. 6.

### 1.4.2. Pack Operation Control Unit

The pack operation control unit may perform operation control of the battery pack in response to the determination result of the comparison and determination unit.

As the determination result, when it is determined that it is a general state in which there is no external shock, a normal operation of the battery pack can be maintained.

On the other hand, as the determination result, when it is determined that it is a state in which the weak shock is continuously applied, a higher level of safety control operation can be performed than a case where it is the general state in which there is no external shock.

On the other hand, as the determination result, when it is determined that it is a state in which a strong shock is applied, a higher level of safety control operation can be performed than a case where it is a state in which the weak shock is continuously applied.

The control unit (not illustrated) may be implemented as a conventional battery BMS included in the BMS module 100 described above and a processor included therein, but is characterized in that it performs the characteristic functions of the present invention described above. In this case, the voltage measurement unit 110 described above may be included as one configuration of the BMS.

### 2. Battery Pack Shock Detecting Method According to the Present Invention

A battery pack shock detecting method according to an embodiment of the present invention is implemented by configuring the reference voltage source V_{ref} for implementing shock detection and the reference resistor R_{ref} connected to the reference voltage source V_{ref} on a BMS board and applying the shock detection module 300 including the non-conductive barrier wall 310 connected to a case of the battery pack with an elastic body, the measurement resistor pattern R₀ which is formed inside the non-conductive barrier wall 310 to be spaced apart therefrom, whose one end is connected to the reference resistor R_{ref}, and which is formed on the board to be fixed, and the first and second resistors R₁ and R₂ respectively connected to both ends of the non-conductive barrier wall 310 through the hinges 320 and respectively having one end disposed adjacent to the measurement resistor pattern R₀ and the other end connected to the ground GND.

### 2.1. Distributed-Voltage Measurement Step

The distributed-voltage measurement step is a step of measuring a distributed voltage at a connection point between the reference resistor R_{ref} connected to the reference voltage source V_{ref} for implementing shock detection on the BMS board and the measurement resistor R₀ of the shock detection module. This step is performed by the voltage measurement unit 110 of the BMS 100 described above.

### 2.2. Whether-a-Shock-Arrival-Condition-is-Satisfied Comparison Step

The whether-a-shock-arrival-condition-is-satisfied comparison step is a step of comparing whether or not the predetermined shock arrival condition is satisfied based on the distributed voltage value measured in the distributed-voltage measurement step.

<Case 1: State without Shock>

In the case 1, whether the measured distributed voltage value is the same as the first reference voltage value may be compared.

Here, the first reference voltage value may be a value calculated by (Equation 1) described above.

<Case 2: State in which a Weak Shock is Continuously Applied>

In the case 2, the number of cycles in which the measured distributed voltage value alternates between the first reference voltage value and the second reference voltage value can be counted and whether or not the counted number has reached a predetermined number of shocks can be compared.

On the other hand, in another embodiment, whether or not the distributed voltage measurement value is continuously detected as the same value as the second reference voltage value for a predetermined number of shocks, after the distributed voltage measurement value is initially detected as the same value as the first reference voltage value, can be compared.

Here, the second reference voltage value may be a value calculated by (Equation 2) described above.

<Case 3: State where Strong Shock is Applied>

In the case 3, whether the measured distributed voltage value has reached the third reference voltage value can be compared.

Here, the third reference voltage value may be a value calculated by (Equation 3) described above.

### 2.3. Shock State Determination Step

In the shock state determination step, the degree of shock applied to the battery pack can be determined according to the comparison result in the whether-a-shock-arrival-condition-is-satisfied comparison step.

<Case 1: State without External Impact>

In the case 1, when the measured distributed voltage value is the same as the first reference voltage value as the result in the whether-a-shock-arrival-condition-is-satisfied comparison step, it can be determined it is a state in which there is no external shock applied to the current battery pack.

<Case 2: State in which a Weak Shock is Continuously Applied>

In the case 2, as a result in the whether-a-shock-arrival-condition-is-satisfied comparison step, when the number of cycles in which the measured distributed voltage value alternates between the first reference voltage value and a second reference voltage value has reached a predetermined number of shocks, or when the number of times the measured distributed voltage value is continuously detected as the same value as the second reference voltage value after the measured distributed voltage value is initially detected as the same value as the first reference voltage value has reached the predetermined number of shocks, it can be determined that it is a state in which a weak shock is continuously applied to the battery pack.

<Case 3: State in which a Strong Shock is Applied>

In the case 3, as the result in the whether-a-shock-arrival-condition-is-satisfied comparison step, when the measured distributed voltage value has reached the third reference voltage value, it can be determined that it is a state in which a strong shock has been applied to the battery pack.

Since the technical principle of determining as above has been described above, a detailed description thereof will be omitted.

### 2.4. Pack Operation Control Step

The pack operation control step is a step of controlling the operation of the battery pack in response to the determination result in the shock state determination step.

As the determination result, when it is determined that it is a general state in which there is no external shock, a normal operation of the battery pack can be maintained and controlled.

On the other hand, as the determination result, when it is determined that it is a state in which the weak shock is continuously applied to the battery pack, it can be controlled to perform a safety operation of a higher level than the case where it is a state in which there is no external shock.

On the other hand, as a result of the determination, when it is determined that it is a state in which a strong shock is applied to the battery pack, it can be controlled to perform a safety operation of a higher level than a case where it is a state in which the weak shock is continuously applied.

That is, control is performed by increasing the level of the safety control operation step by step according to the degree of shock applied to the battery pack.

Meanwhile, although the technical idea of the present invention has been described in detail according to the above embodiments, it should be noted that the above embodiments are for description and not for limitation. In addition, those skilled in the art will understand that various embodiments are possible within the scope of the technical spirit of the present invention.

The reference numerals and signs used in the present invention are as follows.
10: Battery pack
100: BMS
110: Voltage measurement unit
200: Cell module
300: Shock detection module
310: Non-conductive barrier wall
320: Hinge
V_{ref}: Reference voltage source
R_{ref}: Reference resistor
R₀: Measurement resistor
R₁: First resistor
R₂: Second resistor

1. A battery pack comprising:
a battery management system (BMS); and
a shock detection module that detects a shock strength applied to the battery pack, wherein the BMS includes:
a reference voltage source V_{ref} for shock detection;
a reference resistor R_{ref} connected to the reference voltage source V_{ref}; and
a voltage measurement unit that measures a distributed voltage between the reference resistor R_{ref} and a measurement resistor R₀; and
the shock detection module includes:
a non-conductive barrier wall connected to an inside of a case of the battery pack through an elastic body;
the measurement resistor R₀ connected to the reference resistor R_{ref}; and
first and second resistors R₁, R₂ respectively connected to both ends of the non-conductive barrier wall through hinges and respectively having a first end connected to a ground and the other a second end connected to the measurement resistor R₀.

2. The battery pack of claim 1, wherein the BMS further includes:
a comparison and determination unit that compares whether a predetermined shock arrival condition is satisfied based on the distributed voltage measurement value of the voltage measurement unit and determines a degree of shock applied to the battery pack according to the comparison result; and
a pack operation control unit that controls an operation of the battery pack in response to the determination result of the comparison and determination unit.

3. The battery pack of claim 1, wherein
the second ends of the first resistor and the second resistor are disposed at a predetermined interval or less with respect to the measurement resistor R₀, so that when vibration is applied to the battery pack case, the first and second resistors R₁, R₂ come into contact with the measurement resistor R₀ to cause a change in the distributed voltage measurement value of the voltage measurement unit.

4. The battery pack of claim 3, wherein
an interval d1 at which the first resistor R₁ is disposed adjacent to the measurement resistor R₀ is different from an interval d2 at which the second resistor R₂ is disposed adjacent to the measurement resistor R₀.

5. The battery pack of claim 4, wherein
since d1 and d2 are different, the distributed voltage value measured by the voltage measurement unit varies according to a degree of vibration generated in the battery pack.

6. The battery pack of claim 5, wherein
the measurement resistor R₀ is formed at a fixed position on a BMS board constituting the BMS and includes a contact portion with the first and second resistors R₁, R₂, and
the first and second resistors R₁, R₂ are connected to the non-conductive barrier wall with an elastic body, the elastic body being displaceable due to external vibration.

7. The battery pack of claim 6, wherein the distributed voltage is measured as a voltage at the moment when the first and second resistors R₁, R₂ come into contact with the measurement resistor R₀, and
wherein the distributed voltage is measured as a different value according to a degree of the external vibration.

8. The battery pack of claim 2, wherein the comparison and determination unit:
compares whether the distributed voltage measurement value of the voltage measurement unit is the same as a first reference voltage value, and when the distributed voltage measurement value of the voltage measurement unit is the same as a first reference voltage value, determines no shock is being applied to the battery pack,
compares whether a number of cycles in which the distributed voltage measurement value of the voltage measurement unit alternates between the first reference voltage value and a second reference voltage value has reached a predetermined number of shocks, and when the number of cycles has reached the predetermined number of shocks, determines that a weak shock is continuously being applied to the battery pack, and
compares whether the distributed voltage measurement value of the voltage measurement unit has reached a third reference voltage value, and when the distributed voltage measurement value has reached the third reference voltage value, determines that a strong shock has been applied to the battery pack.

9. A battery pack shock detecting method of detecting an external shock state in the battery pack according to claim 1, the battery pack shock detecting method comprising:
a distributed-voltage measurement step of measuring a distributed voltage at a connection point between the reference resistor R_{ref} connected to the reference voltage source V_{ref} for implementing shock detection on a BMS board and the measurement resistor R₀ of the shock detection module;
a whether-a-shock-arrival-condition-is-satisfied comparison step of comparing whether or not a predetermined shock arrival condition is satisfied based on the distributed voltage value measured in the distributed-voltage measurement step; and
a shock state determination step of determining a degree of shock applied to the battery pack according to the comparison result in the whether-a-shock-arrival-condition-is-satisfied comparison step.

10. The battery pack shock detecting method of claim 9, further comprising:
a pack operation control step of controlling an operation of the battery pack in response to a determination result in the shock state determination step.

11. The battery pack shock detecting method of claim 9, wherein
in the whether-a-shock-arrival-condition-is-satisfied comparison step,
whether the measured distributed voltage value is the same as a first reference voltage value is compared,
whether the number of cycles in which the measured distributed voltage value alternates between the first reference voltage value and a second reference voltage value has reached a predetermined number of shocks is compared, and
whether the measured distributed voltage value has reached a third reference voltage value is compared.

12. The battery pack shock detecting method of claim 11, wherein
in the shock state determination step,
when the measured distributed voltage value is the same as the first reference value as a result in the whether-a-shock-arrival-condition-is-satisfied comparison step, it is determined that no external shock has been applied to the battery pack,
when the number of cycles in which the measured distributed voltage value alternates between the first reference voltage value and a second reference voltage value has reached a predetermined number of shocks, it is determined that a weak shock is being continuously applied to the battery pack, and
when the measured distributed voltage value has reached a third reference voltage value, it is determined that it is a state in which a strong shock has been applied to the battery pack.
